(19) United States
(12) Patent Application Publication
(10) Pub. No.: US 2007/0253654 A1
(43) Pub. Date: Nov. 1, 2007

(54) Bearing Retainer

(76) Inventors: Setsuo Nagai, Osaka (JP); Takanori Kurokawa, Osaka (JP); Takeshi Tsuda, Osaka (JP)

Correspondence Address: RABIN & Berdo, PC, 1101 14TH STREET, NW, SUITE 500, WASHINGTON, DC, 20005, US

(21) Appl. No.: 11/660,159

(22) PCT Filed: Aug. 17, 2005
(86) PCT No.: PCT/JP05/15024

§ 371 Date: Feb. 14, 2007

(30) Foreign Application Priority Data
Aug. 17, 2004 (JP) 2004-237213

(51) Int. Cl. F16C 19/04

(52) U.S. Cl. 384/456

(57) ABSTRACT

Disclosed is a bearing retainer made of a resin composition comprising a polyamide resin which has a repeating unit represented by the formula (1) below and a repeating unit represented by the formula (2) below in which formulae R¹ and R² represent three kinds of groups, namely a p-phenylene group, a linear alkylene group having 6-10 carbon atoms, and a branched chain alkylene group having 6-10 carbon atoms. Such a bearing retainer can be used in various applications since it has sufficiently good resistance to a wider variety of lubricating oils in a wider temperature range when compared with conventional resin hearing retainers.

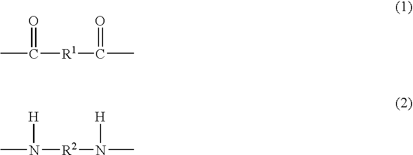

### FIELD OF THE INVENTION

The present invention relates to a bearing retainer for maintaining a rolling element of a rolling bearing.

### BACKGROUND ART

There has been a high demand for producing a bearing retainer of resins from a standpoint of weight saving of rolling bearings, and of VE (Value engineering)/VA (Value Analysis). However, for example, in rolling bearings used for gear transmissions of automobiles etc., oil lubrication with lubricating oil is used instead of grease. Since the lubricating oil includes additives such as extreme-pressure additives etc. that accelerate deterioration of propeties of resins in many cases, bearing retainers for many rolling bearings used with oil lubrication are still manufactured with metals as usual, and therefore resinification is not yet progressed. Today, resin-made bearing retainers are applied only with very limited lubricating oils. Furthermore, lubricating oils allowing use for the resin-made bearing retainers has only an operating upper limit temperatures for the above-described bearing retainers only in a range about as much as 20 to 30° C. lower than the operating upper limit temperature of the same bearing retainers under an oxidative deterioration environment. Therefore, demanded now is bearing retainers having excellent resistance in a wider temperature range, for as many kinds of lubricating oils as possible.

As bearing retainers having resistance to lubricating oils, patent document 1 discloses a bearing retainer obtained by molding a resin composition comprising: an aromatic polyamide made of an aromatic dicarboxylic acid component unit including at least a terephthalic acid component unit, and a linear aliphatic diamine component unit with a carbon number of 6 to 18; and a glass fiber. Patent document 2 discloses a bearing retainer obtained by molding a resin composition comprising: the above-mentioned aromatic polyamide; a modified polyolefin graft-modified with acrylic acid etc.; and a glass fiber.
Patent document 1: JP, 03-143957, A
Patent document 2: JP, 04-327024, A

### DISCLOSURE OF THE INVENTION

### Problem to be Solved by the Invention

However, according to examinations of the present inventors, each bearing retainer disclosed in Patent documents 1 and 2 fails to exhibit enough resistance in a sufficiently wide temperature range with respect to sufficiently broad range of lubricating oils, and therefore it is clear that the lubricating oils need further improvement.

An object of the present invention is to provide a resin-made bearing retainer having sufficiently excellent resistance in a wider temperature range with respect to broader kind of lubricating oils, and allowing use in various applications.

### Means for Solving Problem

The present invention is a bearing retainer molded with a resin composition comprising a polyamide, the polyamide including:
a repeating unit represented by a formula (1); 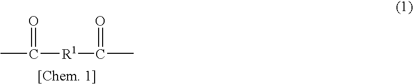
and
a repeating unit represented by a formula (2), 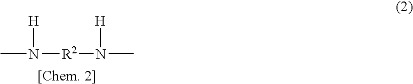
wherein R¹ and R² in both of the formulas represent three kinds of groups of a p-phenylene group, a linear alkylene group having a carbon number of 6 to 10, and a branched chain alkylene group having a carbon number of 6 to 10.

### Effect of the Invention

Since, in the present invention, the p-phenylene group has a function for making rigid a principal chain of the polyamide among the three kinds of groups, rigidification of a principal chain of the polyamide by a function of the p-phenylene group improves heat-resisting property of a bearing retainer, and allows increase of an operating upper limit temperature of the bearing retainer in lubricating oils.

In addition, according to examinations of the present inventors, since the branched alkylene group having a carbon number of 6 to 10 has a function for improvong resistance of the polyamide with respect to extreme-pressure additives included in the lubricating oil among the three kinds of groups, the function of the branched alkylene group can improve the resistance of the bearing retainer to various lubricating oils. Therefore, since the present invention provides excellent resistance with respect to sufficiently more kinds of lubricating oils in a wider temperature range, the present invention makes it possible to provide a resin-made bearing retainer usable for various applications.

In addition, according to the present invention, since the linear alkylene group having a carbon number of 6 to 10 used in combination with the above-mentioned two kinds of groups has a function for providing moderate disorder of regularity in repeating units in the principal chain of the polyamide, and simultaneously has a high degree of freedom and flexibility of rotation of bonds, the linear alkylene group can suppress excessive rigidification of the principal chain of the polyamide, and can also improve moldability of the polyamide in injection molding etc.

Furthermore, use of three kinds of the groups in combination can provide moderate flexibility and toughness to the bearing retainer, and can improve shock resistance of the bearing retainer against impact in rotation of the rolling bearing. Furthermore, for example in a bearing retainer having a pocket for holding rolling elements with an undercut, the use in combination can also prevent generation of breaks and cracks in case of removing out of the molded bearing retainer from a metal mold, and pushing-in of the rolling element into the pocket.

### BRIEF DESCRIPTION OF THE DRAWINGS

FIG. 1 is a graph illustrating relationships between immersion periods and retentions of tensile strengths to initial values before immersion when bearing retainers manufactured in Examples and Comparative examples of the present invention were immersed in a hot lubricating oil.

### EMBODIMENT OF THE INVENTION

A bearing retainer of the present invention is molded with a resin composition comprising a polyamide, the polyamide including:
a repeating unit represented by a formula (1); and 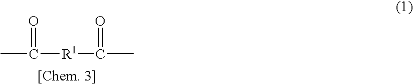
a repeating unit represented by a formula (2), 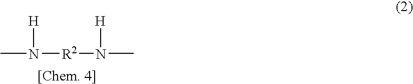
where R¹ and R² in both of the formulas represent three kinds of groups of a p-phenylene group, a linear alkylene group having a carbon number of 6 to 10, and a branched chain alkylene group having a carbon number of 6 to 10.

A linear alkylene group having a carbon number 6 to 10 among the above-described three kinds of groups include: hexamethylene group [—(CH₂)₆—], heptamethylene group [—(CH₂)₇—], octamethylene group [—(CH₂)₈—], nonamethylene group [—(CH₂)₉—], and decamethylene group [—(CH₂)₁₀—]. The linear alkylene groups may be used independently, and two or more may be used in combination.

A branched chain alkylene group having a carbon number 6 to 10 include: 2,2-dimethyl tetramethylene group [—CH₂—C(CH₃)₂—(CH₂)₂—], 2,3-dimethyl tetramethylene group [—CH₂—CH(CH₃)—CH(CH₃)—CH₂—], 2-ethyl-tetramethylene group [—CH₂—CH(C₂H₅)—(CH₂)₂—], 2-methyl pentamethylene group [—CH₂—CH(CH₃)—(CH₂)₃—], 3-methyl pentamethylene group [—(CH₂)₂—CH(CH₃)—(CH₂)₂—], 2,3-dimethyl pentamethylene group [—CH₂—CH(CH₃)—CH(CH₃)—(CH₂)₂—], 2,4-dimethyl pentamethylene group [—CH₂—CH(CH₃)—CH₂—CH(CH₃)—CH₂—], 2-methyl hexamethylene group [—CH₂—CH(CH₃)—(CH₂)₄—], 3-methyl hexamethylene group [—(CH₂)₂—CH(CH₃)—(CH₂)₃—], 2,4-dimethyl hexamethylene group [—CH₂—CH(CH₃)—CH₂—CH(CH₃)—(CH₂)₂—], 2,5-dimethyl hexamethylene group [—CH₂—CH(CH₃)—(CH₂)₂—CH(CH₃)—CH₂—], 2-methyl heptamethylene group [—CH₂—CH(CH₃)—(CH₂)₅—], 3-methyl heptamethylene group [—(CH₂)₂—CH(CH₃)—(CH₂)₄—], 4-methyl heptamethylene group [—(CH₂)₃—CH(CH₃)—(CH₂)₃—], 2,4-dimethyl heptamethylene group [—CH₂—CH(CH₃)—CH₂—CH(CH₃)—(CH₂)₃—] etc. Also the branched alkylene groups may be used independently, and two or more may be used in combination.

Polyamides obtained by arbitrary combination of the above-described three kinds of groups may be used as the polyamides. In consideration of balance of the effects obtained by each group described-above, a proportion of the three kinds of groups included in the polyamide is preferably within a range wherein a molar ratio of (p-phenylene group)/(alkylene group) of the p-phenylene group and a total of two kinds of the alkylene groups satisfies an equation (i).

$$\frac{( p \text{-} phenylene group )}{( alkylene group )} = 1.2 / 1 to 1 / 1.2 \qquad ( i )$$

A proportion of the p-phenylene groups less than the above-described range may possibly fail to give enough effect of improving heat-resisting property of the bearing retainer and of simultaneously increasing an operating upper limit temperature of the bearing retainer in lubricating oils by rigidification of a principal chain of the polyamide by the p-phenylene group. Alternatively, a proportion of the p-phenylene groups more than the above-described range relatively reduces a proportion of the branched chain alkylene groups and may possibly fail to give sufficient effect of improving resistance of the bearing retainer to various lubricating oils due to the branched chain alkylene groups.

In addition, since a proportion of the linear alkylene groups also relatively decreases, there may be a possibility of failing to give sufficient effect of suppression of excessive rigidification of the principal chain of the polyamide by the linear alkylene groups, and of simultaneous improvement in moldability of the polyamide using injection molding etc. In addition, for a bearing retainer having a pocket with an undercut, there may be a possibility of giving easy generation of breaks and cracks in the bearing retainer when molding thereof and press fitting of a rolling element thereto.

Furthermore, with respect to a proportion of the linear alkylene groups and the branched chain alkylene groups, a molar ratio of (linear alkylene group)/(branched chain alkylene group) preferably is within a range satisfying an equation (ii).

$$\frac{( linear alkylene group )}{( branched chain alkylene group )} = 2 / 1 to 1 / 4 \qquad ( ii )$$

A proportion of the branched chain alkylenes less than the above-described range may possibly fail to give sufficient effect of improving resistance of the bearing retainer to various lubricating oils by the branched chain alkylene groups. In addition, the linear alkylene groups less than the above-described range may possibly fail to give enough effect of improvement in moldability of the polyamide in injection molding etc. based on suppression of excessive rigidification of principal chains of the polyamide by the linear alkylene group. In addition, in a bearing retainer having a pocket with an undercut, there may be a possibility of giving easy generation of breaks and cracks in the bearing retainer when molding thereof and press fitting of a rolling element thereto.

As polyamides including the three kinds of groups at an afore-mentioned proportion, for example, a polyamide may be mentioned wherein one of R¹ and R² in the formulas (1) and (2) represents p-phenylene group, and the other represents a mixed groups of the two kinds of alkylene groups. Examples of the polyamides will be shown below.

(I) A polyamide including:

a repeating unit represented by a formula (1-1), where R¹ in the formula (1) represents a p-phenylene group; 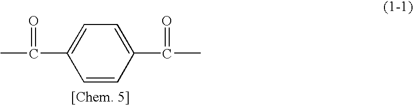
at least one kind of repeating units represented by a formula (2-1), where R² in the formula (2) represents a linear alkylene group having a carbon number 6 to 10 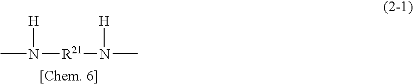
[R²¹ in the formula represents a linear alkylene group having a carbon number 6 to 10]; and
at least one kind of repeating units represented by a formula (2-2), where, R²in the formula (2) represents a branched chain alkylene group having carbon number 6 to 10 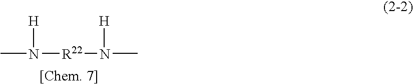
[R²² in the formula represents a branched chain alkylene group having a carbon number 6 to 10].
(II) A polyamide including:
at least one kind of repeating units represented by a formula (1-2), where R¹ in the formula (1) represents a linear alkylene group having a carbon number 6 to 10 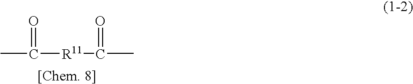
[R¹¹ in the formula represents a linear alkylene group having a carbon number 6 to 10];
at least one kind of repeating units represented by a formula (1-3), where R¹ in the formula (1) represents a branched chain alkylene group having a carbon number 6 to 10 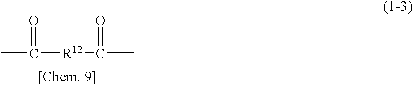
[R¹² in the formula represents a branched chain alkylene group having a carbon number 6 to 10]; and
a repeating unit represented by a formula (2-3), where R² in the formula (2) represents a p-phenylene group.

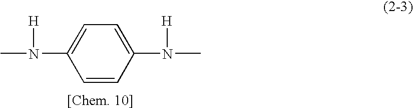

However, as the polyamide such polyamides may be used, for example, wherein a part of R¹ represents a p-phenylene group, and the remainder is at least one of the two kinds of alkylene groups; a part of R² is a p-phenylene group, and a remainder is at least one of the two kinds of alkylene groups; and a proportion of the three kinds of groups is within the above-described range.

The polyamides may be synthesized, by conventional methods, by a reaction in a range of a stoichiometric amount of a dicarboxylic acid component represented by a formula (3), and 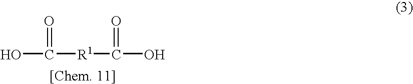
a diamine component represented by a formula (4).
[Chem. 12]
H₂N—R²—NH₂ (4)

For example, the polyamide (I) may be synthesized by reacting terephthalic acid in which R¹ in the formula (3) represents a p-phenylene group; at least one kind of linear aliphatic diamines in which R² in the formula (4) represents a linear alkylene group having a carbon number 6 to 10; and at least one kind of branched chain aliphatic diamines in which R² in the formula (4) represents a branched chain alkylene group having a carbon number 6 to 10, at a proportion of approximately 1 mol of a total amount of the two kinds of diamines with respect to 1 mol of the terephthalic acid.

In addition, the polyamide of (II) may be synthesized by reacting at least one kind of linear aliphatic dicarboxylic acids in which R¹ in the formula (3) represents a linear alkylene group having a carbon number 6 to 10; at least one kind of branched chain aliphatic dicarboxylic acids in which R¹ in the formula (3) represents a branched chain alkylene group having a carbon number 6 to 10; and a p-phenylenediamine in which R² in the formula (4) represents a p-phenylene group, at a proportion of approximately 1 mol of a total amount of the two kinds of dicarboxylic acids with respect to 1 mol of the p-phenylenediamine.

Methods for reacting each of the components to synthesize the polyamide include, for example, a method of polycondensation of each of the components by a solution method or an interfacial method, and a method of solution polymerization or solid state polymerization after synthesis of an oligomer by heating of nylon salts formed from each of the components etc.

Other resins may be blended with a resin composition as a base substance of the bearing retainer including the polyamide in a range that does not degrade properties of the polyamide. Other resins that may be blended include various polyamides other than the above-described polyamide. However, in consideration of prevention of deterioration of resistance of the bearing retainer to extreme-pressure additives etc. included in lubricating oils, a blending proportion of the other resins is preferably not more than 10 parts by weight with respect to 100 parts by weight of the polyamide.

Reinforcing fibers, fillers, and various kinds of other additives may be blended to the resin composition in order to reinforce the bearing retainer, as in conventional cases. The reinforcing fibers include, for example, glass fibers, carbon fibers, fibrous wollastonite, silicon carbide fibers, boron fibers, alumina fibers, Si—Ti—C—O fibers, metal fibers (copper, steel, stainless steel, etc.), aromatic polyamide (aramid) fibers, potassium titanate whiskers, graphite whiskers, silicon carbide whiskers, silicon nitride whiskers, alumina whiskers etc.

The fillers include, for example, powders of heat resistant resins, such as phenol resin, silicone resin, fluororesin, polyamideimide resin, polyimide resin, and aromatic polyamide resin; and powders of inorganic substances, such as graphite, alumina, silica, silicon carbide, silicon nitride, carbon black, molybdenum disulfide, talc, diatomaceous earth, asbestos, magnesium carbonate, calcium carbonate, glass beads, and silica balloons, etc.

In blending of the reinforcing fibers and the fillers, either of them may be blended with the resin composition, and both of them maybe blended. A blending ratio of the independent component in independent blending of either of the reinforcing fibers or the fillers, or a blending ratio of a sum of both of them in blending of both of them is preferably 10 to 40 parts by weight to 100 parts by weight of a total amount of resins including the polyamide. The amount of resins is the amount of the polyamide, when the resins is only polyamide, or the total amount of the polyamide and other resins, when the resin is a mixture of them. A blending ratio of reinforcing fibers and/or fillers of less than the above-described range may not allow sufficient exhibition of effect of addition of these components, that is, effect of reinforcing the bearing retainer. In addition, a blending ratio exceeding the range may give possible deterioration of moldability of the resin compositions by injection molding.

The bearing retainer of the present invention may be manufactured in such a manner that the respective components are molded in shapes usable as a molding material having a shape of pellets or powder after melting and kneading of each of the components to be molded by an injection molding etc. as in conventional methods. A structure of the present invention may be applied to bearing retainers having any shapes for various rolling bearings, such as ball bearings, needle roller bearings, cylindrical roller bearings, and cone roller bearings etc.

The above-described bearing retainer of the present invention has sufficiently excellent resistance in a wider temperature range and to broader kind of lubricating oils as compared with conventional polyamide bearing retainers, and thereby it may be used in various application, such as rolling bearings used under environment of oil lubrication where resin-made bearing retainers have not been applicable. Therefore, use by incorporation to rolling bearings etc. in gear transmissions of automobiles where metal bearing retainers have been used until now will enable weight saving of the rolling bearings, and lower cost etc.

### EXAMPLE

### Example 1

A polyamide of 70 parts by weight made of a repeating unit represented by the formula (1-1), wherein R¹ in the formula (1) represents a p-phenylene group; two kinds of repeating units represented by the formula (2), that is, a repeating unit represented by the formula (2-1), wherein R²¹ in the formula (2-1) represents a hexamethylene group; and a repeating unit represented by the formula (2-2), wherein R²² in the formula (2-2) represents a 2-methylhexamethylene group, and a glass fiber of 30 parts by weight were melted and kneaded together to obtain a resin composition. A bearing retainer was manufactured by injection molding using the resin composition.

In the polyamide, the molar ratio of (p-phenylene group)/(alkylene group) represented by the equation (i) of p-phenylene group and total of two kinds of alkylene groups was 1/1, and a molar ratio of (linear alkylene group)/(branched chain alkylene group) represented by the equation (ii) of hexamethylene group as a linear alkylene group and 2-methylhexamethylene group as a branched chain alkylene group was 2/3 to 1/4.

### Comparative Example 1

A polyamide of 70 parts by weight made of a repeating unit represented by the formula (1-1) wherein R¹ in the formula (1) represents a p-phenylene group; and a repeating unit represented by the formula (2) wherein R² in the formula (2) represents a hexamethylene group, and a glass fiber of 30 parts by weight were melted and kneaded together to obtain a resin composition. A bearing retainer was manufactured by injection molding using the resin composition. A molar ratio (p-phenylene group)/(hexamethylene group) of p-phenylene group and hexamethylene group in the polyamide was 1/1.

### Comparative Example 2

A polyamide of 70 parts by weight made of a repeating unit represented by the formula (1-1) wherein R¹ in the formula (1) represents a p-phenylene group; a repeating unit represented by the formula (1) wherein R¹ in the formula (1) represents a tetramethylene group; and a repeating unit represented by the formula (2) wherein R² in the formula (2) represents a hexamethylene group, and a glass fiber of 30 parts by weight were melted and kneaded together to obtain a resin composition. A bearing retainer was manufactured by injection molding using the resin composition. In the polyamide, a molar ratio of (p-phenylene group +tetramethylene group)/(hexamethylene group) of a total of p-phenylene group and tetramethylene group with hexamethylene group were 1/1, and a molar ratio of p-phenylene group and tetramethylene group was (p-phenylene group)>(tetramethylene group).

<Oil Resistance Test>

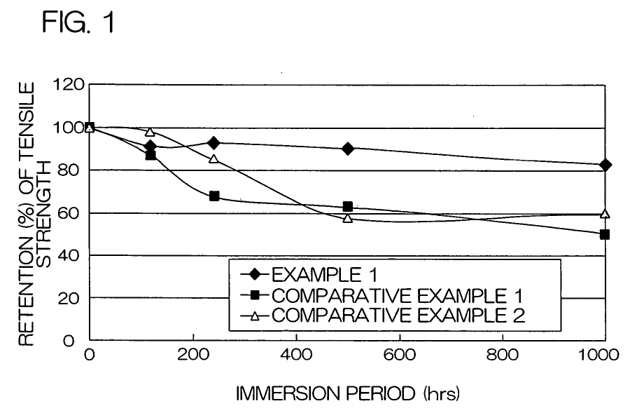

Two or more bearing retainers according to Example and Comparative examples, respectively, were prepared. Each one of the bearing retainers was measured for a tensile strength to obtain an initial value of the tensile strength. Subsequently, remaining two or more bearing retainers of each samples were immersed in a lubricating oil for automatic transmissions for automobiles including extreme-pressure additives heated by 150° C. And at immesion periods of 120 hours, 240 hours, 500 hours, and 1000 hours from immersion start, each one of the bearing retainers manufactured in Example and Comparative examples, respectively, was withdrawn from the oil. Each of the samples was measured for a tensile strength, and retention (%) of the tensile strength to the initial value was determind. Relationships between the immersion periods and the retentions were plotted in FIG. 1.

With reference to the figure, it is clarified that the bearing retainer of Example 1 exhibits smaller decreasing rate of the tensile strength as compared with the samples of Comparative examples 1 and 2, and that it maintains not less than 80% of the tensile strength of the initial value even after 1000 hours of immersion.

1. A bearing retainer molded with a resin composition comprising a polyamide, the polyamide including:
a repeating unit represented by a formula (1); and 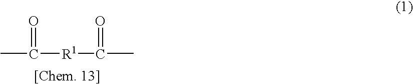
a repeating unit represented by a formula (2), 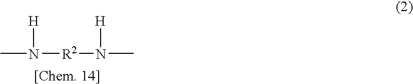
wherein R¹ and R² in both of the formulas represent three kinds of groups of a p-phenylene group, a linear alkylene group having a carbon number of 6 to 10, and a branched chain alkylene group having a carbon number of 6 to 10.

2. The bearing retainer according to claim 1, wherein the polyamide includes a repeating unit represented by a formula (1-1); 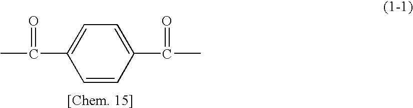
a repeating unit represented by a formula (2-1) 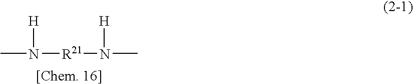
[where R²¹ represents a linear alkylene group having a carbon number of 6 to 10]; and
a repeating unit represented by a formula (2-2). 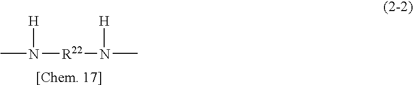
[where R²² represents a branched chain alkylene group having a carbon number of 6 to 10]

3. The bearing retainer according to claim 1, wherein the polyamide includes a repeating unit represented by a formula (1-2) 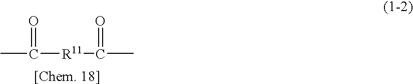
[where R¹¹ represents a linear alkylene group having a carbon number of 6 to 10];
a repeating unit represented by a formula (1-3) 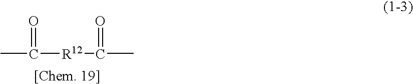
[where R¹² represents a branched chain alkylene group having a carbon number of 6 to 10]; and
a repeating unit represented by a formula (2-3).

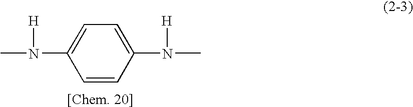

4. The bearing retainer according to claim 1, wherein the polyamide is synthesized by reacting a dicarboxylic acid component represented by a formula (3), and 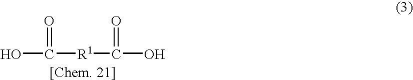
a diamine component represented by a formula (4).
[Chem. 22]
H₂N—R²—NH₂ (4)

5. The bearing retainer according to claim 1 used in a state being incorporated in rolling bearing of a transmission of an automobile.
